(19) United States
(12) Patent Application Publication
(10) Pub. No.: US 2012/0004156 A1
(43) Pub. Date: Jan. 5, 2012

(54) RINSE ADDED AMINOSILICONE CONTAINING COMPOSITIONS AND METHODS OF USING SAME

(76) Inventors: Rajan Keshav Panandiker, West Chester, OH (US); Nicholas David Vetter, North Bend, OH (US); Kerry Andrew Vetter, Cincinnati, OH (US); Julie Ann O'Neil, Dillsboro, IN (US)

(21) Appl. No.: 13/171,520

(22) Filed: Jun. 29, 2011

Related U.S. Application Data
(60) Provisional application No. 61/360,229, filed on Jun. 30, 2010.

(51) Int. Cl. C11D 3/60

(52) U.S. Cl. 510/516; 510/521

(57) ABSTRACT

The instant disclosure relates to rinse-added fabric care compositions comprising an aminosilicone and methods of making and using same. Such rinse-added fabric care compositions provide an improved fabric feel and/or softening. Methods of using such compositions, including contacting a fabric with the fabric care composition, are also disclosed. Articles comprising such compositions are also described.

### CROSS-REFERENCES TO RELATED APPLICATIONS

This application claims priority under 35 U.S.C. §119(e) to U.S. Provisional Application Serial No. 61/360,229 filed Jun. 30, 2010.

### FIELD OF THE INVENTION

The instant disclosure relates to rinse-added fabric care compositions comprising an aminosilicone and methods of making and using same.

### BACKGROUND OF THE INVENTION

The use of aminosilicones in rinse-added fabric care compositions to provide improved fabric feel and/or softening is known. However, aminosilicones previously utilized in fabric care compositions typically have several negatives associated with their use in treatments for fabrics. For example, aminosilicones previously utilized in fabric care compositions can produce discoloration of the fabrics and fabric care compositions. It is also believed that aminosilicones can react with adjunct materials comprising an aldehyde or ketone groups to discolor the composition. In many instances these materials comprising aldehyde or ketone groups are perfume components.

It has been taught that the discoloration of rinse-added fabric care compositions can be avoided by physically separating the materials comprising aldehydes and ketones from the aminosilicone, e.g., by encapsulating the materials comprising aldehydes and ketones in a microcapsule. It has also been taught that the discoloration of rinse-added fabric care compositions containing aminosilicones can be avoided by reducing the concentration of materials comprising aldehydes and ketones, e.g., providing compositions that are essentially free of an unsaturated aldehyde.

Accordingly, there remains a need to develop an improved rinse-added fabric care composition that provides improved fabric feel and/or softening, while limiting discoloration of the fabrics and fabric care compositions, without having to remove or separate (e.g., encapsulate) materials comprising aldehydes and ketones.

### SUMMARY OF THE INVENTION

The present disclosure relates to rinse-added fabric care compositions comprising aminosilicone for providing improved fabric feel and/or softening. Methods of using such compositions, including contacting a fabric with the fabric care composition, are also disclosed. Articles comprising such compositions are also described herein.

### DETAILED DESCRIPTION OF THE INVENTION

Definitions

As used herein, the term “fabric care and/or treatment composition” includes products for treating fabrics or other surfaces in the area of fabric and home care, and includes granular or powder-form all-purpose or “heavy-duty” washing agents, including cleaning detergents; liquid, gel or paste-form all-purpose washing agents; liquid fine-fabric detergents; hand dishwashing agents or light duty dishwashing agents, including those of the high-foaming type; rinse-added agents, liquid cleaning and disinfecting agents, fabric conditioning products including fabric conditioning products including softening and/or freshening that may be in liquid, solid and/or dryer sheet form; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists. All of such products may be in standard, concentrated or even highly concentrated form even to the extent that such products may in certain aspect be non-aqueous.

As used herein, articles such as “a” and “an” when used in a claim, are understood to mean one or more of what is claimed or described.

As used herein, the terms “include”, “includes” and “including” are meant to be non-limiting.

As used herein, the term “additive” means a composition or material that may be used separately from (but including before, after, or simultaneously with) the detergent during a laundering process to impart a benefit to the treated textile.

As used herein, the term “amine equivalent” refers to the amount of amine present in an aminosilicone, as determined using the method disclosed herein.

The term “cationic polymer” refers to a polymer having a net cationic charge. Polymers containing amine groups or other protonable groups are included in the term “cationic polymers,” wherein the polymer is protonated at the pH of the intended use.

As used herein, the term “fluid” includes liquid, gel, paste, and gas product forms.

As used herein, “substantially free of” a component means that no amount of that component is deliberately incorporated into the composition.

As used herein, the term “external” structurant means a material which has as its primary function that of providing rheological alteration, such as to increase viscosity of a fluid such as a liquid or gel or paste. External structurants may or may not, in and of themselves, provide any significant fabric cleaning or fabric care benefit.

“Liquid composition” as used herein, refers to compositions that are in a form selected from the group of: “pourable liquid”; “gel”; “cream”; and combinations thereof.

“Pourable liquid” as defined herein refers to a liquid having a viscosity of less than about 2000 mPa*s at 25° C. and a shear rate of 20 sec⁻¹. In some embodiments, the viscosity of the pourable liquid may be in the range of from about 200 to about 1000 mPa*s at 25° C. at a shear rate of 20 sec⁻¹. In some embodiments, the viscosity of the pourable liquid may be in the range of from about 200 to about 500 mPa*s at 25° C. at a shear rate of 20 sec⁻¹. The viscosity may be measured using conventional methods. For example, viscosity may be measured using a TA Instruments AR1000 cone and plate viscometer, manufactured by TA Instruments (New Castle, Del.), using manufacturer-suggested operating conditions at 25° C.

“Gel” as defined herein refers to a transparent or translucent liquid having a viscosity of greater than about 2000 mPa*s at 25° C. and at a shear rate of 20 sec⁻¹. In some embodiments, the viscosity of the gel may be in the range of from about 3000 to about 10,000 mPa*s at 25° C. at a shear rate of 20 sec⁻¹ and greater than about 5000 mPa*s at 25° C. at a shear rate of 0.1 sec⁻¹.

“Cream” and “paste” are used interchangeably and as defined herein refer to opaque liquid compositions having a viscosity of greater than about 2000 mPa*s at 25° C. and a shear rate of 20 sec⁻¹. In some embodiments, the viscosity of the cream may be in the range of from about 3000 to about 10,000 mPa*s at 25° C. at a shear rate of 20 sec⁻¹, or greater than about 5000 mPa*s at 25° C. at a shear rate of 0.1 sec⁻¹.

As used herein, an “effective amount” of a material or composition means the amount needed to accomplish an intended purpose, for example, to impart a desired level of fabric care benefit to a substrate.

As used herein, the term “perfume microcapsule” is used herein in the broadest sense to include a perfume core that is encapsulated by a shell. Unless indicated otherwise, the term “nanocapsule” is within the scope of the term “microcapsule.”

As used herein, the term “perfume” means any odoriferous material or any material which acts as a malodor counteractant. Non-limiting examples of a perfume are described in published USPA No. 2003-0104969 A1, paragraphs 46-81.

As used herein, the term “polymer” includes homopolymer, copolymer or terpolymer and polymers with 4 or more type of monomers.

As used herein, the term “diluent” means an inert material used to dilute a perfume that is encapsulated. Examples of diluents include isopropyl myristate, propylene glycol, poly(ethylene glycol), or mixtures thereof.

As used herein, the term “situs” includes paper products, fabrics, garments, hard surfaces, hair and skin.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Compositions

Applicants recognized that the rinse-added fabric care and/or treatment composition disclosed herein address one or more of the problems described above associated with the use of aminosilicones. In particular, Applicants recognized that the disclosed compositions comprising specific aminosilicones having specific amine equivalent values in combination with materials comprising an aldehyde and/or ketone group, e.g., perfumes, provide improved fabric feel (and freshness) without the discoloration of the fabrics and fabric care compositions.

Without being bound by theory, Applicants believe that the discoloration of the fabrics and fabric care compositions is caused by oxidation of amine groups in the aminosilicone and that ingredients comprising an aldehyde and/or ketone group react with the amine groups to form imines, which produces fabric and/or product discoloration. It is believed that this discoloration can be reduced by selecting aminosilicones having specific amine equivalent values, such that fewer amine groups are available for reaction with aldehyde and/or ketone groups, thereby allowing for the use of a variety of materials comprising aldehyde and/or ketone groups, e.g., perfumes.

Fabric care and/or treatment compositions comprising an aminosilicone, a deposition aid, and a fabric softening active are disclosed. Said compositions may be in the form of a fluid, and in some aspects, are rinse-added compositions. Said compositions may further be in the form of an additive.

In one aspect, the fabric care and/or treatment composition may comprise from about 0.1% to about 10%, from about 0.5% to about 6% or from about 1% to about 3% by weight of the aminosilicone having the structure of Formula I:

[R₁R₂R₃SiO_{1/2}]ₙ[(R₄Si(X—Z)O_{2/2}]ₖ[R₄R₄SiO_{2/2}]ₘ[R₄SiO_{3/2}]ⱼ (Formula I)

wherein
i) R₁, R₂, R₃ and R₄ may each be independently selected from H, C₁-C₂₀ alkyl, C₁-C₂₀ substituted alkyl, C₆-C₂₀ aryl, C₆-C₂₀ substituted aryl, alkylaryl, C₁-C₂₀ alkoxy and combinations thereof.
ii) X may comprise a divalent alkylene radical comprising 2-12 carbon atoms, or may be independently selected from the group consisting of —(CH₂)s-; —CH₂—CH(OH)—CH₂—;

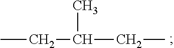

and mixtures thereof, wherein s is on average from about 2 to about 10;
iii) Z may be selected from the group consisting of

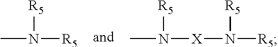

wherein each R₅ may be selected from the group consisting of H, C₁-C₂₀ alkyl, C₁-C₂₀ substituted alkyl, and combinations thereof;
iv) k may be on average from about 2 to about 10, or from about 3 to about 10; or from about 3 to about 8;
v) m may be on average from about 100 to about 2,000, or from about 150 to about 1,000;
vi) n may be on average from about 2 to about 10, or about 2 to about 4, or 2; and
vii) j may be on average from about 0 to about 10, or about 0 to about 4, or 0.

In one aspect,
i) each R₁ may be independently selected from H, OH, methyl, C₁-C₂₀ alkoxy, and combinations thereof;
ii) R₂, R₃ and R₄ may be methyl groups;
iii) Z may be selected from

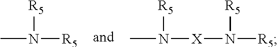

wherein R₅ may be selected from the group consisting of H, C₁-C₂₀ alkyl, and combinations thereof
iv) X is independently selected from the group consisting of —(CH₂)s-; —CH₂—CH(OH)—CH₂—;

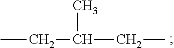

and mixtures thereof, wherein s is on average from about 2 to about 6;
v) k may be on average from about 2 to about 20, or from about 3 to about 10; or from about 3 to about 8;
vi) m may be on average from about 150 to about 1,000;
vii) n may be on average from about 2 to about 6, or 2; such that n=j+2; and
viii) j may be from about 0 to about 4, alternatively 0.

As used herein, the nomenclature SiO“n”/2 represents the ratio of oxygen and silicon atoms. For example, SiO_{1/2} means that one oxygen is shared between two Si atoms. Likewise SiO_{2/2} means that two oxygen atoms are shared between two Si atoms and SiO_{3/2} means that three oxygen atoms are shared are shared between two Si atoms.

In another aspect, the aminosilicone may have an amine equivalent of from about 2500 g/mol to about 30,000 g/mol, or from about 3000 g/mol to about 25,000 g/mol.

In one aspect, at least about 70%, or at least about 80%, or at least about 90% of the aminosilicone has a particle size of from about 0.1 microns to about 10 microns, or from about 0.2 microns to about 5 microns, or from about 0.5 microns to about 2 microns.

Deposition Aid

In one aspect, the fabric care and/or treatment composition may comprise from about 0.01% to about 10%, or from about 0.05 to about 5%, or from about 0.1 to about 3% of a deposition aid. Suitable deposition aids are disclosed in, for example, US Published Application Number 2008/0242584.

In one aspect, the one or more deposition aids may be a cationic or amphoteric polymer.

In one aspect, the one or more deposition aids may be a cationic polymer. Cationic polymers in general and their method of manufacture are known in the literature. In one aspect, the deposition aid may comprise a cationic polymer having a cationic charge density of from about 0.1 milliequivalents/g to about 23 milliequivalents/g (meq/g) from about 0.1 meq/g to about 12 meq/g, or from about 0.5 meq/g to about 7 meq/g, at the pH of intended use of the composition. For amine-containing polymers, wherein the charge density depends on the pH of the composition, charge density is measured at the pH of the intended use of the product. Such pH will generally range from about 2 to about 11, more generally from about 2.5 to about 9.5. Charge density is calculated by dividing the number of net charges per repeating unit by the molecular weight of the repeating unit. The positive charges may be located on the backbone of the polymers and/or the side chains of polymers. For example, for the copolymer of acrylamide and diallyldimethylammonium chloride with a monomer feed ratio of 70:30, the charge density of the feed monomers is about 3.05 meq/g. However, if only 50% of diallyldimethylammonium is polymerized, the polymer charge density is only about 1.6 meq/g. The polymer charge density is measured by dialyzing the polymer with a dialysis membrane or by NMR. For polymers with amine monomers, the charge density depends on the pH of the carrier. For these polymers, charge density is measured at a pH of 7.

In one aspect, the cleaning and/or treatment composition may comprise an amphoteric deposition aid polymer so long as the polymer possesses a net positive charge. Said polymer may have a cationic charge density of from about 0.05 milliequivalents/g to about 12 milliequivalents/g.

Suitable polymers may be selected from the group consisting of cationic or amphoteric polysaccharide, polyethylene imine and its derivatives, and a synthetic polymer made by polymerizing one or more cationic monomers selected from the group consisting of N,N-dialkylaminoalkyl acrylate, N,N-dialkylaminoalkyl methacrylate, N,N-dialkylaminoalkyl acrylamide, N,N-dialkylaminoalkylmethacrylamide, quaternized N,N dialkylaminoalkyl acrylate quaternized N,N-dialkylaminoalkyl methacrylate, quaternized N,N-dialkylaminoalkyl acrylamide, quaternized N,N-dialkylaminoalkylmethacrylamide, Methacryloamidopropyl-pentamethyl-1,3-propylene-2-ol-ammonium dichloride, N,N,N,N′,N′,N″,N″-heptamethyl-N″-3-(1-oxo-2-methyl-2-propenyl)aminopropyl-9-oxo-8-azo-decane-1,4,10-triammonium trichloride, vinylamine and its derivatives, allylamine and its derivatives, vinyl imidazole, quaternized vinyl imidazole and diallyl dialkyl ammonium chloride and combinations thereof, and optionally a second monomer selected from the group consisting of acrylamide, N,N-dialkyl acrylamide, methacrylamide, N,N-dialkylmethacrylamide, C₁-C₁₂ alkyl acrylate, C₁-C₁₂ hydroxyalkyl acrylate, polyalkylene glycol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS) and their salts. The polymer may optionally be branched or cross-linked by using branching and crosslinking monomers. Branching and crosslinking monomers include ethylene glycoldiacrylate divinylbenzene, and butadiene. A suitable polyethyleneinine useful herein is that sold under the tradename Lupasol® by BASF, AG, Lugwigshafen, Germany

In another aspect, the deposition aid may be selected from the group consisting of cationic polysaccharide, polyethylene imine and its derivatives, poly(acrylamide-co-diallyldimethylammonium chloride), poly(acrylamide-methacrylamidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-Methacryloamidopropyl-pentamethyl-1,3-propylene-2-ol-ammonium dichloride), Suitable deposition aids include Polyquaternium-1, Polyquaternium-5, Polyquaternium-6, Polyquaternium-7, Polyquaternium-8, Polyquaternium-11, Polyquaternium-14, Polyquaternium-22, Polyquaternium-28, Polyquaternium-30, Polyquaternium-32 and Polyquaternium-33, as named under the International Nomenclature for Cosmetic Ingredients.

In one aspect, the deposition aid may comprise polyethyleneimine or a polyethyleneimine derivative. In another aspect, the deposition aid comprises a cationic acrylic based polymer. In another aspect, the deposition aid may comprise a cationic polyacrylamide. In another aspect, the deposition aid may comprise a polymer comprising polyacrylamide and polymethacrylamidoproply trimethylammonium cation. In another aspect, the deposition aid may comprise poly(acrylamide-N-dimethyl aminoethyl acrylate) and its quaternized derivatives. In this aspect, the deposition aid may be that sold under the tradename Sedipur®, available from BTC Specialty Chemicals, a BASF Group, Florham Park, N.J. In another aspect, the deposition aid may comprise poly(acrylamide-co-methacrylamidopropyltrimethyl ammonium chloride). In another aspect, the deposition aid is a non-acrylamide based polymer, such as that sold under the tradename Rheovis® CDE, available from Ciba Specialty Chemicals, a BASF group, Florham Park, N.J., or as disclosed in published USPA 2006/0252668.

Additional suitable deposition aids include the cationic polymers described in the U.S. Patent Application claiming the benefit of Provisional Application No. 61/320032.

In another aspect, the cleaning and/or treatment composition may comprise a deposition aid selected from the group consisting of cationic or amphoteric polysaccharides. In one aspect, the deposition aid may be selected from the group consisting of cationic and amphoteric cellulose ethers, cationic or amphoteric galactomannan, cationic guar gum, cationic or amphoteric starch, and combinations thereof

Another group of suitable cationic polymers may include alkylamine-epichlorohydrin polymers which are reaction products of amines and oligoamines with epicholorohydrin, for example, those polymers listed in, for example, U.S. Pat. Nos. 6,642,200 and 6,551,986. Examples include dimethylamine-epichlorohydrin-ethylenediamine, available under the trade name Cartafix® CB and Cartafix® TSF from Clariant, Basel, Switzerland.

Another group of suitable synthetic cationic polymers may include polyamidoamine-epichlorohydrin (PAE) resins of polyalkylenepolyamine with polycarboxylic acid. The common PAE resins are the condensation products of diethylenetriamine with adipic acid followed by a subsequent reaction with epichlorohydrin. They are available from Hercules Inc. of Wilmington Del. under the trade name Kymene™ or from BASF AG (Ludwigshafen, Germany) under the trade name Luresin™. These polymers are described in Wet Strength resins and their applications edited by L. L. Chan, TAPPI Press (1994).

The weight-average molecular weight of the polymer may be from about 500 Daltons to about 5,000,000 Daltons, from about 1,000 Daltons to about 2,000,000 Daltons, or from about 2,500 Daltons to about 1,500,000 Daltons, as determined by size exclusion chromatography relative to polyethyleneoxide standards with RI detection. In one aspect, the MW of the cationic polymer may be from about 500 Daltons to about 37,500 Daltons.

The cationic polymers may contain charge neutralizing anions such that the overall polymer is neutral under ambient conditions. Non-limiting examples of suitable counter ions (in addition to anionic species generated during use) include chloride, bromide, sulfate, methylsulfate, sulfonate, methylsulfonate, carbonate, bicarbonate, formate, acetate, citrate, nitrate, and mixtures thereof.

Aldehyde or Ketone

In one aspect, the composition may comprise from about from about 0.0001% to about 10%, or from about 0.001% to about 2%, by weight of the composition of at least one material comprising an aldehyde and/or ketone group.

Suitable materials comprising an aldehyde and/or ketone group include biocontrol ingredients such as biocides, antimicrobials, bactericides, fungicides, algaecides, mildewcides, disinfectants, antiseptics, insecticides, vermicides, plant growth hormones. Suitable antimicrobials include chlorhexidine diacetate, glutaraldehyde, cinnamon oil and cinnamaldehyde, polybiguanide, eugenol, thymol, geraniol, or mixtures thereof.

In one aspect, the material comprising an aldehyde and/or ketone group may be a perfume ingredient. These may include, for example, one or more perfume ingredients listed in Table I.

TABLE I
Exemplary Perfume Ingredients

| Number | IUPAC Name | Trade Name | Functional Group |
|---|---|---|---|
| 1 | Benzaldehyde | Benzaldehyde | Aldehyde |
| 2 | 6-Octenal, 3,7-dimethyl- | Citronellal | Aldehyde |
| 3 | Octanal, 7-hydroxy-3,7-dimethyl- | Hydroxycitronellal | Aldehyde |
| 4 | 3-(4-tert-butylphenyl)butanal | Lilial | Aldehyde |
| 5 | 2,6-Octadienal, 3,7-dimethyl- | Citral | Aldehyde |
| 6 | Benzaldehyde, 4-hydroxy-3- | Vanillin | Aldehyde |
| | methoxy- | | |
| 7 | 2-(phenylmethylidene)octanal | Hexyl Cinnamic Aldehyde | Aldehyde |
| 8 | 2-(phenylmethylidene)heptanal | Amyl Cinnamic Aldehyde | Aldehyde |
| 9 | 3-Cyclohexene-1-carboxaldehyde, | Ligustral, | Aldehyde |
| | dimethyl- | | |
| 10 | 3-Cyclohexene-1-carboxaldehyde, | Cyclal C | Aldehyde |
| | 3,5-dimethyl- | | |
| 11 | Benzaldehyde, 4-methoxy- | Anisic Aldehyde | Aldehyde |
| 12 | 2-Propenal, 3-phenyl- | Cinnamic Aldehyde | Aldehyde |
| 13 | 5-Heptenal, 2,6-dimethyl- | Melonal | Aldehyde |
| 14 | Benzenepropanal, 4-(1,1- | Bourgeonal | Aldehyde |
| | dimethylethyl)- | | |
| 15 | Benzenepropanal, .alpha.-methyl-4- | Cymal | Aldehyde |
| | (1-methylethyl)- | | |
| 16 | Benzenepropanal, .beta.-methyl-3- | Florhydral | Aldehyde |
| | (1-methylethyl)- | | |
| 17 | Dodecanal | Lauric Aldehyde | Aldehyde |
| 18 | Undecanal, 2-methyl- | Methyl Nonyl | Aldehyde |
| | | Acetaldehyde | |
| 19 | 10-Undecenal | Intreleven Aldehyde Sp | Aldehyde |
| 20 | Decanal | Decyl Aldehyde | Aldehyde |
| 21 | Nonanal | Nonyl Aldehyde | Aldehyde |
| 22 | Octanal | Octyl Aldehyde | Aldehyde |
| 23 | Undecenal | Iso C-11 Aldehyde | Aldehyde |
| 24 | Decanal, 2-methyl- | Methyl Octyl | Aldehyde |
| | | Acetaldehyde | |
| 25 | Undecanal | Undecyl Aldehyde | Aldehyde |
| 26 | 2-Undecenal | 2-Undecene-1-Al | Aldehyde |
| 27 | 2,6-Octadiene, 1,1-diethoxy-3,7- | Citrathal | Aldehyde |
| | dimethyl- | | |
| 28 | 3-Cyclohexene-1-carboxaldehyde, | Vernaldehyde | Aldehyde |
| | 1-methyl-4-(4-methylpentyl)- | | |
| 29 | Benzenepropanal, 4-methoxy- | Canthoxal | Aldehyde |
| | .alpha.-methyl- | | |
| 30 | 9-Undecenal, 2,6,10-trimethyl- | Adoxal | Aldehyde |
| 31 | Acetaldehyde, [(3,7-dimethyl-6- | Citronellyl | Aldehyde |
| | octenyl)oxy]- | Oxyacetaldehyde | |
| 32 | Benzeneacetaldehyde | Phenyl Acetaldehyde | Aldehyde |
| 33 | Benzeneacetaldehyde, .alpha.- | Hydratropic Aldehyde | Aldehyde |
| | methyl- | | |
| 34 | Benzenepropanal, .beta.-methyl- | Trifernal | Aldehyde |
| 35 | 2-Buten-1-one, 1-(2,6,6-trimethyl-3- | Delta Damascone | Ketone |
| | cyclohexen-1-yl)- | | |
| 36 | 2-Buten-1-one, 1-(2,6,6-trimethyl-2- | Alpha Damascone | Ketone |
| | cyclohexen-1-yl)- | | |
| 37 | 2-Buten-1-one, 1-(2,6,6-trimethyl-1- | Damascone Beta | Ketone |
| | cyclohexen-1-yl)-, (Z)- | | |
| 38 | 2-Buten-1-one, 1-(2,6,6-trimethyl- | Damascenone | Ketone |
| | 1,3-cyclohexadien-1-yl)- | | |
| 39 | (E)-1-(2,4,4-trimethylcyclohex-2- | Iso-Damascone | Ketone |
| | en-1-yl)but-2-en-1-one | | |
| 40 | 3-Buten-2-one, 3-methyl-4-(2,6,6- | Ionone Gamma Methyl | Ketone |
| | trimethyl-2-cyclohexen-1-yl)- | | |
| 41 | 3-Buten-2-one, 4-(2,6,6-trimethyl-2- | Inone Alpha | Ketone |
| | cyclohexen-1-yl)-, (E)- | | |
| 42 | 3-Buten-2-one, 4-(2,6,6-trimethyl-1- | Ionone Beta | Ketone |
| | cyclohexen-1-yl)- | | |
| 43 | 1-naphthalen-2-ylethanone | Methyl beta naphthyl | Ketone |
| | | ketone | |
| 44 | methyl 3-oxo-2- | Methyl-Dihydrojasmonate | Ketone |
| | pentylcyclopentaneacetate | | |
| 45 | 1-(5,5-dimethyl-1- | Neobutenone | Ketone |
| | cyclohexenyl)pent-4-en-1-one | | |
| 46 | 1-(2,3,8,8-tetramethyl-1,3,4,5,6,7- | Iso-E-Super | Ketone |
| | hexahydronaphthalen-2-yl)ethanone | | |
| 47 | 4-(4-hydroxyphenyl)butan-2-one | Para-Hydroxy-Phenyl- | Ketone |
| | | Butanone | |
| 48 | | Methyl cedrylone | Ketone |
| 49 | 2-Cyclohexen-1-one, 2-methyl-5-(1- | Laevo Carvone | Ketone |
| | methylethenyl)-, (R)- | | |
| 50 | (2R,5S)-5-methyl-2-propan-2- | Menthone | Ketone |
| | ylcyclohexan-1-one | | |
| 51 | 1,7,7-trimethylbicyclo[2.2.1]heptan- | Camphor | Ketone |
| | 2-one | | |
| 52 | 2-hexylcyclopent-2-en-1-one | iso jasmone; | Ketone |

Fabric Softening Active

In one aspect, the fabric care and/or treatment composition may comprise from about 0.01 to about 90%, from about 1% to about 40%, from about 3% to about 30%, from about 5% to about 20%, or from about 10% to about 15% by weight of the composition of a fabric softening active.

“Fabric Softener Active” means any active suitable for softening fabric. In one aspect, the fabric softener active may comprise a biodegradable fabric softening agent. In one aspect, the agent may be cationic. A general type of fabric softener active that may be used can be referred to as a quaternary ammonium compound. Exemplary quaternary ammonium compounds include alkylated quaternary ammonium compounds, ring or cyclic quaternary ammonium compounds, aromatic quaternary ammonium compounds, diquaternary ammonium compounds, alkoxylated quaternary ammonium compounds, amidoamine quaternary ammonium compounds, ester quaternary ammonium compounds, and mixtures thereof. Examples of fabric softener actives are described in U.S. Pat. No. 7,381,697, column 3, line 43—column 4, line 67; U.S. Pat. No. 7,135,451, column 5, line 1—column 11, line 40. See also U.S. Pat. Nos. 4,424,134; 4,767,547; 5,545,340; 5,545,350; 5,562,849; and 5,574,179.

Fabric Softening Active Compounds

The fabric softening active may comprise, as the principal active, compounds of the following Formula (I):

{R₄₋ₘ—N⁺—[X—Y—R¹]ₘ}X⁻ Formula (I)

wherein each R comprises either hydrogen, a short chain C₁-C₆, in one aspect a C₁-C₃ alkyl or hydroxyalkyl group, for example methyl, ethyl, propyl, hydroxyethyl, and the like, poly(C₂₋₃ alkoxy), polyethoxy, benzyl, or mixtures thereof; each X may independently be (CH₂)ₙ, —CH₂—CH(CH₃)— or —CH—(CH₃)—CH₂—; each Y may comprise —O—(O)C—, —C(O)—O—, —NR—C(O)—, or —C(O)—NR—; each m may be 2 or 3; each n may be from 1 to about 4, in one aspect 2; the sum of carbons in each R¹, plus one when Y is —O—(O)C— or —NR—C(O)—, may be C₁₂-C₂₂, or C₁₄-C₂₀, with each R¹ being a hydrocarbyl, or substituted hydrocarbyl group; and X⁻ may comprise any softener-compatible anion. In one aspect, the softener-compatible anion may comprise chloride, bromide, methylsulfate, ethylsulfate, sulfate, and nitrate. In another aspect, the softener-compatible anion may comprise chloride or methyl sulfate.

In another aspect, the fabric softening active may comprise the general Formula (II):

[R₃N⁺CH₂CH(YR¹)(CH₂YR¹)]X⁻ Formula (II)

wherein each Y, R, R¹, and X⁻ have the same meanings as before. Such compounds include those having the Formula (III):

[CH₃]₃N⁽⁺⁾[CH₂CH(CH₂O(O)CR¹)O(O)CR¹]Cl⁽⁻⁾ Formula (III)

wherein each R may comprise a methyl or ethyl group. In one aspect, each R¹ may comprise a C₁₅ to C₁₉ group. As used herein, when the diester is specified, it can include the monoester that is present.

These types of agents and general methods of making them are disclosed in U.S. Pat. No. 4,137,180. An example of a suitable DEQA (2) is the “propyl” ester quaternary ammonium fabric softener active comprising the formula 1,2-di(acyloxy)-3-trimethylammoniopropane chloride.

In one aspect, the fabric softening active may comprise the Formula (IV):

[R₄₋ₘ—N⁺—R¹ₘ]X⁻ Formula (IV)

wherein each R, R¹, m and X⁻ have the same meanings as before.

In a further aspect, the fabric softening active may comprise the Formula (V):

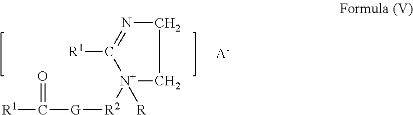

wherein each R and R¹ have the definitions given above; R² may comprise a C₁₋₆ alkylene group, in one aspect an ethylene group; and G may comprise an oxygen atom or an —NR— group; and A⁻ is a suitable anion.

In a yet further aspect, the fabric softening active may comprise the Formula (VI):

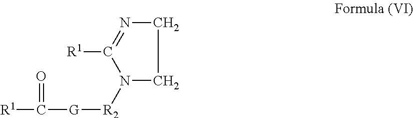

wherein R¹, R² and G are defined as above.

In a further aspect, the fabric softening active may comprise condensation reaction products of fatty acids with dialkylenetriamines in, e.g., a molecular ratio of about 2:1, said reaction products containing compounds of the Formula (VII):

R¹—C(O)—NH—R²—NH—R³—NH—C(O)—R¹ Formula (VII)

wherein R¹, R² are defined as above, and R³ may comprise a C₁₋₆ alkylene group, or an ethylene group and wherein the reaction products may optionally be quaternized by the additional of an alkylating agent such as dimethyl sulfate. Such quaternized reaction products are described in additional detail in U.S. Pat. No. 5,296,622.

In a yet further aspect, the fabric softening active may comprise the Formula (VIII):

[R¹—C(O)—NR—R²—N(R)₂—R³—NR—C(O)—R¹]⁺A⁻ Formula (VIII)

wherein R, R¹, R², R³ and A⁻ are defined as above;

In a yet further aspect, the fabric softening active may comprise reaction products of fatty acid with hydroxyalkylalkylenediamines in a molecular ratio of about 2:1, said reaction products containing compounds of the Formula (IX):

R¹—C(O)—NH—R²—N(R³OH)—C(O)—R¹ Formula (IX)

wherein R¹, R² and R³ are defined as above;

In a yet further aspect, the fabric softening active may comprise the Formula (X):

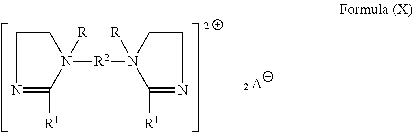

wherein R, R¹, R², and A⁻ are defined as above.

In yet a further aspect, the fabric softening active may comprise the Formula (XI);

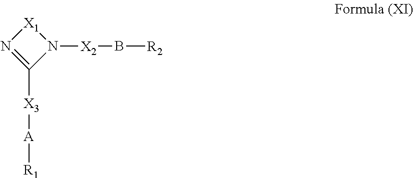

wherein;

X₁ may comprise a C₂₋₃ alkyl group, in one aspect, an ethyl group;

X₂ and X₃ may independently comprise C₁₋₆ linear or branched alkyl or alkenyl groups, in one aspect, methyl, ethyl or isopropyl groups;

R₁ and R₂ may independently comprise C₈₋₂₂ linear or branched alkyl or alkenyl groups;

characterized in that;

A and B are independently selected from the group comprising —O—(C═O)—, —(C═O)—O—, or mixtures thereof, in one aspect, —O—(C═O)—.

Non-limiting examples of fabric softening actives comprising Formula (I) are N,N-bis(stearoyl-oxy-ethyl)N,N-dimethyl ammonium chloride, N,N-bis(tallowoyl-oxy-ethyl)N,N-dimethyl ammonium chloride, N,N-bis(stearoyl-oxy-ethyl)N-(2 hydroxyethyl)N-methyl ammonium methylsulfate.

A non-limiting example of fabric softening actives comprising Formula (III) is 1,2-di(stearoyl-oxy)-3-trimethyl ammoniumpropane chloride.

Non-limiting examples of fabric softening actives comprising Formula (IV) may include dialkylenedimethylammonium salts such as dicanoladimethylammonium chloride, di(hard)tallowdimethylammonium chloride, dicanoladimethylammonium methylsulfate. An example of commercially available dialkylenedimethylammonium salts usable in the present invention is dioleyldimethylammonium chloride available from Witco Corporation under the trade name Adogen® 472 and dihardtallow dimethylammonium chloride available from Akzo Nobel Arquad 2HT75.

A non-limiting example of fabric softening actives comprising Formula (V) may include 1-methyl-1-stearoylamidoethyl-2-stearoylimidazolinium methylsulfate wherein R¹ is an acyclic aliphatic C₁₅-C₁₇ hydrocarbon group, R² is an ethylene group, G is a NH group, R is a methyl group and A⁻ is a methyl sulfate anion, available commercially from the Witco Corporation under the trade name Varisoft®.

A non-limiting example of fabric softening actives comprising Formula (VI) is 1-tallowylamidoethyl-2-tallowylimidazoline wherein R¹ may comprise an acyclic aliphatic C₁₅-C₁₇ hydrocarbon group, R² may comprise an ethylene group, and G may comprise a NH group.

A non-limiting example of a fabric softening active comprising Formula (VII) is the reaction products of fatty acids with diethylenetriamine in a molecular ratio of about 2:1, said reaction product mixture comprising N,N″-dialkyldiethylenetriamine having the Formula (XII):

R¹—C(O)—NH—CH₂CH₂—NH—CH₂CH₂—NH—C(O)—R¹ Formula (XII)

wherein R¹ is an alkyl group of a commercially available fatty acid derived from a vegetable or animal source, such as Emersol® 223LL or Emersol® 7021, available from Henkel Corporation, and R² and R³ are divalent ethylene groups.

A non-limiting example of Compound (VIII) is a difatty amidoamine based softener having the Formula (XIII):

[R¹—C(O)—NH—CH₂CH₂—N(CH₃)(CH₂CH₂OH)—CH₂CH₂—NH—C(O)—R¹]⁺CH₃SO₄⁻ Formula (XIII)

wherein R¹ is an alkyl group. An example of such compound is that commercially available from the Witco Corporation e.g. under the trade name Varisoft® 222LT.

A non-limiting example of a fabric softening active comprising Formula (IX) is the reaction products of fatty acids with N-2-hydroxyethylethylenediamine in a molecular ratio of about 2:1, said reaction product mixture comprising the Formula (XIV):

R¹—C(O)—NH—CH₂CH₂—N(CH₂CH₂OH)—C(O)—R¹ Formula (XIV)

wherein R¹—C(O) is an alkyl group of a commercially available fatty acid derived from a vegetable or animal source, such as Emersol® 223LL or Emersol® 7021, available from Henkel Corporation.

A non-limiting example of a fabric softening active comprising Formula (X) is the diquaternary compound having the Formula (XV):

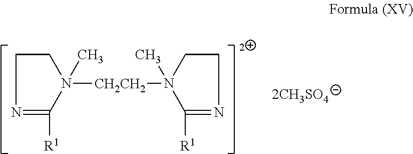

wherein R¹ is derived from fatty acid. Such compound is available from Witco Company.

A non-limiting example of a fabric softening active comprising Formula (XI) is a dialkyl imidazoline diester compound, where the compound is the reaction product of N-(2-hydroxyethyl)-1,2-ethylenediamine or N-(2-hydroxyisopropyl)-1,2-ethylenediamine with glycolic acid, esterified with fatty acid, where the fatty acid is (hydrogenated) tallow fatty acid, palm fatty acid, hydrogenated palm fatty acid, oleic acid, rapeseed fatty acid, hydrogenated rapeseed fatty acid or a mixture of the above.

It will be understood that combinations of softener actives disclosed above are suitable for use herein.

In the cationic nitrogenous salts herein, the anion A⁻, which comprises any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. In one aspect, the anion A may comprise chloride or methylsulfate. The anion, in some aspects, may carry a double charge. In this aspect, A⁻ represents half a group.

In one aspect, the fabric care and/or treatment composition may comprise a second softening agent selected from the group consisting of polyglycerol esters (PGEs), oily sugar derivatives, and wax emulsions. Suitable PGEs include those disclosed in USPA 61/089,080. Suitable oily sugar derivatives and wax emulsions include those disclosed in USPA 2008-0234165 A1.

Adjunct Materials

For the purposes of the present invention, the following non-limiting list of adjuncts illustrated hereinafter may be suitable for use in the instant compositions and may be desirably incorporated in certain aspects, for example to assist or enhance performance, for treatment of the substrate to be cleaned, or to modify the aesthetics of the composition as is the case with perfumes, colorants, dyes or the like. It is understood that such adjuncts may be in addition to the components that are supplied via Applicants' compositions. The precise nature of these additional components, and levels of incorporation thereof, will depend on the physical form of the composition and the nature of the operation for which it is to be used. Suitable adjunct materials may include perfume microcapsules, stabilizers, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, rheology modifiers, water processing aids and/or pigments. In addition to the disclosure below, suitable examples of such other adjuncts and levels of use are found in U.S. Pat. Nos. 5,576,282, 6,306,812 B1 and 6,326,348 B1.

Each adjunct ingredient is not essential to Applicants' compositions. Thus, certain embodiments of Applicants' compositions may not contain one or more of the following adjuncts materials: perfume microcapsules, stabilizers, bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, additional fabric softeners, carriers, hydrotropes, processing aids and/or pigments. However, when one or more adjuncts are present, such one or more adjuncts may be present as detailed below:

Perfume Microcapsules—The composition of the present invention further comprises a perfume microcapsule. Suitable perfume microcapsules may include those described in the following references: US 2003-215417 A1; US 2003-216488 A1; US 2003-158344 A1; US 2003-165692 A1; US 2004-071742 A1; US 2004-071746 A1; US 2004-072719 A1; US 2004-072720 A1; EP 1393706 A1; US 2003-203829 A1; US 2003-195133 A1; US 2004-087477 A1; US 2004-0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; U.S. RE 32,713; U.S. Pat. No. 4,234,627. In another embodiment, the perfume microcapsule comprises a friable microcapsule (e.g., aminoplast copolymer comprising perfume microcapsule, esp. melamine-formaldehyde or urea-formaldehyde). In another embodiment, the perfume microcapsule comprises a moisture-activated microcapsule (e.g., cyclodextrin comprising perfume microcapsule). In another embodiment, the perfume microcapsule may be coated with a polymer (alternatively a charged polymer)

Stabilizer—The compositions may contain one or more stabilizers and thickeners. Any suitable level of stabilizer may be of use; exemplary levels include from about 0.01% to about 20%, from about 0.1% to about 10%, or from about 0.1% to about 3% by weight of the composition. Non-limiting examples of stabilizers suitable for use herein include crystalline, hydroxyl-containing stabilizing agents, trihydroxystearin, hydrogenated oil, or a variation thereof, and combinations thereof. In some aspects, the crystalline, hydroxyl-containing stabilizing agents may be water-insoluble wax-like substances, including fatty acid, fatty ester or fatty soap. In other aspects, the crystalline, hydroxyl-containing stabilizing agents may be derivatives of castor oil, such as hydrogenated castor oil derivatives, for example, castor wax. The hydroxyl containing stabilizers are disclosed in U.S. Pat. Nos. 6,855,680 and 7,294,611. Other stabilizers include thickening stabilizers such as gums and other similar polysaccharides, for example gellan gum, carrageenan gum, and other known types of thickeners and rheological additives. Exemplary stabilizers in this class include gum-type polymers (e.g. xanthan gum), polyvinyl alcohol and derivatives thereof, cellulose and derivatives thereof including cellulose ethers and cellulose esters and tamarind gum (for example, comprising xyloglucan polymers), guar gum, locust bean gum (in some aspects comprising galactomannan polymers), and other industrial gums and polymers.

Surfactants—The compositions may comprise an additional surfactant or surfactant system wherein the surfactant may be selected from nonionic and/or anionic and/or cationic surfactants and/or ampholytic and/or zwitterionic and/or semi-polar nonionic surfactants. The surfactant may comprise from about 0.1%, from about 1%, or even from about 5% by weight of the cleaning compositions to about 99.9%, to about 80%, to about 35%, or even to about 30% by weight of the cleaning compositions.

Builders—The compositions may comprise one or more detergent builders or builder systems. When present, the compositions will typically comprise at least about 1% builder, or from about 5% or 10% to about 80%, 50%, or even 30% by weight, of said builder. Builders include the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

Dye Transfer Inhibiting Agents—The compositions may include one or more dye transfer inhibiting agents. Suitable polymeric dye transfer inhibiting agents include polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the compositions to about 10%, about 2%, or even about 1% by weight of the compositions.

Dispersants—The compositions may comprise dispersants. Suitable water-soluble organic materials are the homo- or co-polymeric acids or their salts, in which the polycarboxylic acid may comprise at least two carboxyl radicals separated from each other by not more than two carbon atoms.

Enzymes—The compositions may comprise one or more detergent enzymes which provide cleaning performance and/or fabric care benefits. Examples of suitable enzymes include hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

Enzyme Stabilizers—Enzymes for use in compositions, for example, detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' compositions may include catalytic metal complexes. One type of metal-containing bleach catalyst may be a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methyl-enephosphonic acid) and water-soluble salts thereof. Such catalysts are disclosed in U.S. Pat. No. 4,430,243. If desired, the compositions herein can be catalyzed by means of a manganese compound. Such compounds and levels of use are well known in the art and include, for example, the manganese-based catalysts disclosed in U.S. Pat. No. 5,576,282. Cobalt bleach catalysts useful herein are known, and are described, for example, in U.S. Pat. Nos. 5,597,936 and 5,595,967. Such cobalt catalysts are readily prepared by known procedures, such as taught for example in U.S. Pat. Nos. 5,597,936, and 5,595,967. Compositions herein may also suitably include a transition metal complex of a macropolycyclic rigid ligand—abbreviated as “MRL”. As a practical matter, and not by way of limitation, the compositions and processes herein can be adjusted to provide on the order of at least one part per hundred million of the benefit agent MRL species in the aqueous washing medium, and may provide from about 0.005 ppm to about 25 ppm, from about 0.05 ppm to about 10 ppm, or even from about 0.1 ppm to about 5 ppm, of the MRL in the wash liquor. Suitable transition-metals in the instant transition-metal bleach catalyst include manganese, iron and chromium. Suitable MRL's herein are a special type of ultra-rigid ligand that is cross-bridged such as 5,12-diethyl-1,5,8,12-tetraazabicyclo[6.6.2]hexa-decane. Suitable transition metal MRLs may be readily prepared by known procedures, such as taught for example in WO 00/32601, and U.S. Pat. No. 6,225,464.

Methods of Making

The fabric care compositions of the present disclosure can be formulated into any suitable form and prepared by any process chosen by the formulator, non-limiting examples of which are described in U.S. Pat. Nos. 5,879,584; 5,691,297; 5,574,005; 5,569,645; 5,565,422; 5,516,448; 5,489,392; and 5,486,303.

In one aspect, the compositions disclosed herein may be prepared by combining the components thereof in any convenient order and by mixing, e.g., agitating, the resulting component combination to form a phase stable cleaning composition. In one aspect, a fluid matrix may be formed containing at least a major proportion, or even substantially all, of the fluid components, e.g., nonionic surfactant, the non-surface active liquid carriers and other optional fluid components, with the fluid components being thoroughly admixed by imparting shear agitation to this liquid combination. For example, rapid stifling with a mechanical stirrer may be employed.

Methods of Using

The fabric care compositions disclosed in the present specification may be used to clean or treat a fabric or other situs such as those described herein. Typically at least a portion of the fabric may be contacted with an embodiment of the aforementioned compositions, in neat form or diluted in a liquor, for example, a wash liquor and then the fabric may be optionally washed and/or rinsed. In one aspect, a fabric may be optionally washed and/or rinsed, contacted with an embodiment of the aforementioned fabric care compositions and then optionally washed and/or rinsed. For purposes of the present disclosure, washing includes scrubbing, and mechanical agitation. The fabric may comprise most any fabric capable of being laundered or treated.

The fabric care compositions disclosed in the present specification can be used to form aqueous solutions for use in the laundering of fabrics. Generally, an effective amount of such compositions may be added to water, such as in a conventional fabric laundering automatic washing machine, to form such aqueous laundering solutions. The aqueous washing solution so formed may then be contacted, in one aspect, under agitation, with the fabrics to be laundered therewith. An effective amount of the composition, such as the compositions disclosed in the present specification, may be added to water to form aqueous solutions that may comprise from about 500 to about 7,000 ppm or even from about 1,000 to about 3,000 ppm of fabric care composition.

In one aspect, a method of providing a benefit to a fabric comprising the step of contacting a fabric with a composition described above in a rinse cycle of an automatic laundry machine is disclosed. In one aspect, the benefit may be selected from the group consisting of removal of wrinkles, prevention of wrinkles, fabric softness, improved fabric feel, garment shape retention, garment shape recovery, elasticity, ease-of-ironing, perfume benefits, anti-pilling, or combinations thereof. In one aspect, the benefit may be an anti-wrinkle benefit. In another aspect, the benefit may be a softening benefit.

Article Comprising Composition

In another aspect, an article comprising a composition as described above is disclosed.

Test Methods

Determination of Amine Equivalent: Amine equivalent is measured by dissolving the aminosilicone of interest in a 1:1 toluene/IPA mixture and titrating 0.1N Hydrochloric acid solution using an auto-titrator to an endpoint of pH=7. Amine equivalent is calculated as molecular weight of the silicone per mole of amine and calculated by the following equation:

Amine Equivalent [g/mol]=Sample Amount (g)×10,000 (Hydrochloric Acid Consumption Amount (mL)×F (Titer)

### EXAMPLES

All values are given as % by weight of the final composition. Components are added in the following order with constant stifling with an overhead mixer using a 45° pitched or Rushton blade at ˜300-500 RPM: Fabric softening active, water, perfume, silicone, deposition aid, PMC. After mixing, these samples are placed into glass jars and sealed with appropriate lids and stored at 70° F. for a period of 72 hours. All values are given as % by weight of the final composition.

TABLE 1
Examples 1-12: Rinse Added Compositions

| | Reference | | |
|---|---|---|---|
| | Composition | Examples 1-6 | Examples 7-12 |
| | Wt % | Wt % | Wt % |
| Fabric Softening Active¹ | 11.0 | 11.0 | 11.0 |
| Perfume² | 0.8 | 0.8 | 0.8 |
| Silicone³ | 5.0 | 5.0 | 5.0 |
| PMC⁴ | | | .65 |
| Deposition aid⁵ | | | 0.10-0.25 |

| | |
|---|---|
| Calcium chloride, water, | Balance to 100% |
| pH buffers, perfume | |
| microcapsules, and other | |
| adjuncts | |

¹N,N-di(tallowoyloxyethyl)-N,N-dimethylammonium chloride, available from Degussa under the trade name of Adogen ® SDMC having an IV value of about 10.
²Perfume contains by weight 13% Lilial, 11% Hexyl Cinnamic Aldehyde, 3.2% Anisic Aldehyde and 72.8% non aldehedic perfume ingredients.
³See Table 2
⁴Perfume microcapsule available from Appleton Paper, Appleton, WI
⁵Polyethyleneimine available from Nippon Shokubai Company, Tokyo, Japan under the trade name Epomin ™ P-1050.

TABLE 2
Details of silicones used in Examples 1-12

| | | | Amine |
|---|---|---|---|
| | | | Equivalent |
| Example | Silicone | Supplier | (g/mol) |
| Examples 1, 7 | KF-873 | Shin-Etsu Silicones, Akron, | 20,000 |
| | | OH | |
| Examples 2, 8 | X22-8699-S | Shin-Etsu Silicones, Akron, | 4300 |
| | | OH | |
| Examples 3, 9 | Y-17578 | Momentive Performance | 3200 |
| | | Materials, Waterford, NY | |
| Examples 4, 10 | Magnasoft ™ | Momentive Performance | 5000^{#} |
| | Plus | Materials, Waterford, NY | |
| Examples 5, 11 | X22-8699-3S | Shin-Etsu Silicones, Akron, | 1900 |
| | | OH | |
| Examples 6, 12 | Y-17579 | Momentive Performance | 2100 |
| | | Materials, Waterford, NY | |

^{#}calculated based on molecular structure

The degree of yellowing is assessed using Hunter LABScan instrument following standard procedure to measure the *b value. Hunter LABScan is calibrated according to instrument specifications and protocol. The parameters of the Hunter LABScan Instrument include Luminance: D65, Color Space: CIELAB, Area View: 1.0, Port Size: 1.0, UV Filter: In, and sample cover cup used to cover port and petri dish from background light interference. Ten milliliters of the sample solution are then transferred from the jar into a clear plastic petri dish (NUNC brand 50×15 mm petri dish from Fisher Scientific, Rochester, N.Y.) with a lid. Samples are then analyzed and the b value is reported. If the visual color change of the sample is in the direction of yellow, the Hunter *b value is reported. To determine the % change in *b versus control, the following equation is applied:

% Yellowing=[(*b sample−*b reference)/*b reference]×100

% Change in *b Values for LFE with
Silicones and Aldehydic Perfume

| | % Change vs nil Si Control |
|---|---|
| Silicone From Example # | (*b value) |
| 1 | 17.4% |
| 2 | 7.0% |
| 3 | 12.4% |
| 4 | 12.9% |
| 5 | 53.7% |
| 6 | 52.5% |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A rinse added composition comprising
a. from about 0.1% to about 10% by weight of the composition an aminosilicone having the structure of Formula I
[R₁R₂R₃SiO_{1/2}]ₙ[(R₄Si(X—Z)O_{2/2}]ₖ[R₄R₄SiO_{2/2}]ₘ[R₄SiO_{3/2}]ⱼ Formula (I)
wherein
i) each R₁, R₂, R₃ and R₄ is independently selected from H, C₁-C₂₀ alkyl, C₁-C₂₀ substituted alkyl, C₆-C₂₀ aryl, C₆-C₂₀ substituted aryl, alkylaryl, C₁-C₂₀ alkoxy and combinations thereof;
ii) X is a divalent alkylene radical comprising 2-12 carbon atoms, or X is independently selected from the group consisting of —(CH₂)s-; —CH₂—CH(OH)—CH₂—; 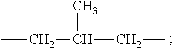
and mixtures thereof, wherein s is on average from about 2 to about 10;
iii) Z is selected from the group consisting of 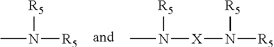
wherein each R₅ is independently selected from H, C₁-C₂₀ alkyl, C₁-C₂₀ substituted alkyl;
iv) k is on average from about 2 to about 20;
v) m is on average from about 100 to about 2,000;
vi) n is on average from about 2 to about 10; and
vii) j is on average from about 0 to about 10;
wherein the aminosilicone has an amine equivalent of from about 2500 g/mol to about 30,000 g/mol;
b. from about 0.01% to about 10% by weight of the composition of a deposition aid comprising a cationic polymer having a charge density of from about 0.1 milliequivalents/g to about 23 milliequivalents/g or amphoteric polymer having a net positive charge; and
c. about 0.0001% to about 10% by weight of the composition of at least one material comprising an aldehyde and/or ketone group;
d. from about 0.01% to about 90% by weight of the composition of a fabric softening active.

2. A composition according to claim 1 wherein
i) each R₁ is independently selected from H, OH, methyl, C₁-C₂₀ alkoxy, and combinations thereof;
ii) R₂, R₃ and R₄ are methyl groups:
iii) Z is selected from 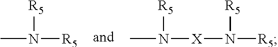
wherein R₅ is selected from the group consisting of H, C₁-C₂₀ alkyl, and combinations thereof;
iv) X is independently selected from the group consisting of —(CH₂)s-; —CH₂—CH(OH)—CH₂—; 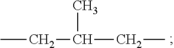
and mixtures thereof, wherein s is on average from about 2 to about 6;
v) k is on average from about 2 to about 20;
vi) m is on average from about 150 to about 1,000;
vii) n is on average from about 2 to about 6, such that n=j+2; and
viii) j is from about 0 to about 4.

3. A composition according to claim 1 wherein the aminosilicone has an amine equivalent of from about 3000 g/mol to about 30,000 g/mol.

4. A composition according to claim 1 wherein the deposition aid comprises a cationic or amphoteric polymer selected from the group consisting of cationic polysaccharide, polyethylene imine and its derivatives, and a synthetic polymer comprising a cationic monomers selected from the group consisting of N,N-dialkylaminoalkyl methacrylate, N,N-dialkylaminoalkyl acrylate, N,N-dialkylaminoalkyl acrylamide, N,N-dialkylaminoalkylmethacrylamide, quaternized N,N-dialkylaminoalkyl methacrylate, quaternized N,N-dialkylaminoalkyl acrylate, quaternized N,N-dialkylaminoalkyl acrylamide, quaternized N,N-dialkylaminoalkylmethacrylamide, vinylamine and its derivatives, allylamine and its derivatives, vinyl imidazole, quaternized vinyl imidazole and diallyl dialkyl ammonium chloride and combinations thereof.

5. A composition according to claim 1 wherein the deposition aid polymer comprises a polymer selected from the group consisting of cationic polysaccharide, polyethylene imine and its derivatives, poly(acrylamide-co-diallyldimethylammonium chloride), poly(acrylamide-methacrylamidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-Methacryloamidopropyl-pentamethyl-1,3-propylene-2-ol-ammonium dichloride).

6. A composition according to claim 1, wherein the deposition aid comprises a cationic polymer selected from the group consisting of polyethyleneimine, polyethyleneimine derivatives, poly(acrylamide-co-quaternized N,N-dimethyl aminoethyl acrylate); poly(acrylamide-methacrylamidopropyltrimethyl ammonium chloride) or combinations thereof.

7. A composition according to claim 1 wherein the material comprising an aldehyde or ketone group is selected from the group consisting of Benzaldehyde; Citronellal; Hydroxycitronellal; Lilial; Citral; Vanillin; Hexyl Cinnamic Aldehyde; Amyl Cinnamic Aldehyde; Ligustral; Cyclal C; Anisic Aldehyde; Cinnamic Aldehyde; Melonal; Bourgeonal; Cymal; Florhydral; Lauric Aldehyde; Methyl Nonyl Acetaldehyde; Intreleven Aldehyde Sp; Decyl Aldehyde; Nonyl Aldehyde; Octyl Aldehyde; Iso C-11 Aldehyde; Methyl Octyl Acetaldehyde; Undecyl Aldehyde; 2-Undecene-1-Al; Citrathal; Vernaldehyde; Canthoxal; Adoxal; Citronellyl Oxyacetaldehyde; Phenyl Acetaldehyde; Hydratropic Aldehyde; Trifernal; Delta Damascone; Alpha Damascone; Damascone Beta Damascenone; Iso-Damascone; Ionone Gamma Methyl; Inone Alpha; Ionone Beta; Methyl beta naphthyl ketone; Methyl-Dihydrojasmonate; Neobutenone; Iso-E-Super; Para-Hydroxy-Phenyl-Butanone; Methyl cedrylone; Laevo Carvone; Menthone; Camphor; iso jasmine and combinations thereof.

8. A composition according to claim 1, wherein the fabric softening active comprises a material selected from the group consisting of quaternary ammonium compounds, polyglycerol esters, oily sugar derivatives, wax emulsions, and combinations thereof.

9. A composition according to claim 1, wherein the composition further comprises a perfume microcapsule, a stabilizer, or a combination thereof.

10. A method of providing a benefit to a fabric comprising the step of contacting the fabric with a composition according to claim 1 in a rinse cycle of an automatic laundry machine.

11. A method according to claim 10 wherein the benefit comprises a benefit selected from the group consisting of removal of wrinkles, prevention of wrinkles, fabric softness, improved fabric feel, garment shape retention, garment shape recovery, elasticity, ease-of-ironing, perfume benefits, anti-pilling, and combinations thereof.

12. A method according to claim 10 wherein the benefit comprises an anti-wrinkle benefit.

13. A method according to claim 10 wherein the benefit comprises a softening benefit.

14. A method according to claim 10 wherein the benefit comprises a freshness benefit.

15. An article comprising a composition according to claim 1.
